(19) United States
(12) Patent Application Publication
(10) Pub. No.: US 2021/0027624 A1
(43) Pub. Date: Jan. 28, 2021

(54) Device for Monitoring the State of Roads, Infrastructure and Traffic

(71) Applicant: Swareflex GmbH, Vomp (AT)

(72) Inventors: Johannes Oberdanner, Axams (AT); Anton Flir, Vomp (AT); Peter Egger, Bad Haring (AT); Markus Kindl, Vomp (AT); Georg Schiestl, Absam (AT)

(21) Appl. No.: 16/980,902

(22) PCT Filed: Mar. 15, 2019
(86) PCT No.: PCT/EP2019/056617

§ 371 Date: Sep. 15, 2020

(30) Foreign Application Priority Data
Mar. 16, 2018 (EP) 18162302.6
Dec. 13, 2018 (EP) 18212322.4

(51) Int. Cl. G08G 1/0967; G08G 1/01; G08G 5/00; H04W 4/40; H04W 4/38

(52) U.S. Cl. CPC G08G 1/096783; G08G 1/096708; G08G 1/0125; H04W 4/38; G08G 5/0039; G08G 5/0091; H04W 4/40; G08G 5/0026

(57) ABSTRACT

The disclosure relates to a device for monitoring the state of roads, infrastructure and traffic, including a plurality of sensor elements, wherein the sensor elements are arranged along at least one section of a road. The sensor elements each have a housing with an underside and an upper side. Furthermore, at least one sensor is provided for detecting a measured parameter, wherein the sensor is connected to an evaluation device arranged in the housing, in particular for autonomous evaluation of the measured parameter is acquired. The evaluation device is designed in such a way that an event and/or a state can be determined from the detected measured parameter.

### CROSS-REFERENCE TO RELATED APPLICATIONS

This application is the United States national phase of International Application No. PCT/EP2019/056617 filed Mar. 15, 2019, and claims priority to European Patent Application Nos. 18162302.6 filed Mar. 16, 2018 and 18212322.4 filed Dec. 13, 2018, the disclosures of which are hereby incorporated by reference in their entirety.

### BACKGROUND OF THE INVENTION

### Field of the Invention

The present disclosure relates to a device for monitoring the state of roads, infrastructure and traffic as well as a method for monitoring the state of roads, infrastructure and traffic with such a device.

### Description of Related Art

In known road monitoring systems, a small number of sensors is provided which are arranged along the road at relatively large distances to each other and usually only detect the presence of vehicles. The information acquired in such a manner are transmitted to a common and central control which controls information boards or the like by means of the acquired data in order to adapt the permitted maximum speed to the detected traffic density, for example.

A disadvantage is that due to the small number of sensors and the relatively large distance between the sensors, a failure of a single sensor can possibly already cause that the entire road monitoring system is not available anymore. A failure of the central control also directly causes a failure of the entire road monitoring system. Furthermore, the road monitoring system indeed acquires data which are used for controlling the traffic within the road section detected by the road monitoring system. However, there is no transmission of the acquired information, for example for large-scale traffic control, or such a traffic control has to be performed manually by relevant staff.

An object of the present disclosure is to provide a device for monitoring the state of roads, infrastructure and traffic which is reliable and versatile.

The object is achieved by a device for monitoring the state of roads, infrastructure and traffic as well as a method for monitoring the state of roads, infrastructure and traffic.

### SUMMARY OF THE INVENTION

The device for monitoring the state of roads, infrastructure and traffic according to the disclosure comprises a plurality of sensor elements. The sensor elements are arranged along at least one section of a road or a driveway. The road or the driveway is particularly a motorway, a two-lane road on which the traffic is directed in both directions or a plurality of directions, but however also each further road, such as cross-town links, highways, federal highways or the like. The road or the driveway can also be a parking space, a car park or an underground car park. Each sensor element has a housing with an underside for securing to a particularly stationary structure and an upper side. The sensor elements also comprise at least one sensor for acquiring a measured parameter. The sensor can be arranged inside the housing, partly outside or completely outside the housing. The individual sensor elements are particularly structured differently. However, the individual sensor elements are preferably identical.

The at least one sensor is preferably connected to an evaluation device arranged in the housing, in particular for autonomous evaluation of the measured parameter acquired. Thus, the evaluation by the evaluation device is carried out particularly without transmitting the acquired measured parameters to an external or central control device. The evaluation device is designed in such a way that an event and/or state can be determined from the acquired measured parameter. Thus, an event or state is determined by the respective sensor element itself. A transmission of the acquired measured parameters is not required. Thus, a fail-safe road monitoring system is provided since upon failure of a sensor element, the road monitoring system still remains functional due to the plurality of independent sensor elements. Furthermore, no central control is required whose failure would cause a failure of the device. Alternatively or additionally, the sensor element is designed for transmitting the measured parameter without previous evaluation, wherein an event and/or state can be determined from the measured parameter of one or several sensor elements.

Preferably, at least one, several or all sensor elements are configured to be secured directly on the road surface. Alternatively, at least one, several or all sensor elements can be arranged in an environment of the traffic infrastructure. The environment is defined as an area extending along the traffic infrastructure. However, said area does not need to directly adjoin the traffic infrastructure but can also be spaced apart therefrom, provided that a suitable interaction between the sensor elements and/or the vehicles and airplanes can always take place. For example, the area can be separated by a building structure (soundproof wall) from the traffic infrastructure. Alternatively, an adapter element or adapter plate can be provided by means of which the respective sensor element is secured on or at the road. Alternatively, the respective sensor element can also be secured to a building wall, a crash barrier, a reflector post, a snow pole, a concrete guidance wall or soundproof wall or a securing system specifically developed for said purpose. Preferably, here an adapter element or an adapter plate is again provided by means of which the respective sensor element is secured to one of the aforementioned structures. Due to the adapter element or the adapter plate, a safe securing is possible, wherein, however, a quick exchange is also guaranteed, for example for maintenance purposes.

Preferably, at least one, several or all sensor elements comprise a solar cell, wherein the solar cell is arranged at the upper side or a lateral surface of the housing, in particular across the entire surface. Alternatively or additionally, at least one, several or all sensor elements have a battery for saving electrical energy. The solar cells and/or the battery enable a durable and self-sufficient power supply of the respective sensor element. Thus, the individual sensor elements, and as a consequence also the device, require little maintenance.

Preferably, a wired power supply is provided which is particularly fail-safe. Said wired power supply can be provided in addition to the solar cell or as an alternative.

The coupling between the sensor element and the wired power supply is preferably established by means of an inductive energy transfer. This is advantageous, provided that the sensor elements are constructed modularly and are secured by means of an adapter to the traffic infrastructure, for example. In this case, the adapter could comprise a first induction coil and the respective sensor element could comprise a second induction coil, so that an energy can be transferred from the first induction coil to the second induction coil. Thus, a complex wiring is omitted when installing the sensor elements.

Preferably, at least one, several or all sensor elements comprise an energy module for generating an energy from vibrations, air movement or the like for energy supply of one or several sensor elements.

Preferably, at least one, several or all sensor elements comprise a reflector element or are connected thereto. The reflector element is particularly arranged at the upper side of the housing. The reflector element particularly comprises one reflection surface which is directed at least partly towards or opposed to the direction of travel. Alternatively or additionally, the reflector element is arranged in order to reflect to a lower and/or upper half space. Incident light from the visible and/or non-visible spectrum, such as infrared or ultraviolet, is reflected by the reflector element at the reflection surface and thus a power-independent guidance of the vehicles in guaranteed in the dark. The reflector element is particularly detachably connected to the respective sensor element and can be connected to the housing through a plug connection, a magnetic connection, adhesive bonding, a velcro connection, a snap-fit connection or a screw connection. The reflector element particularly comprises different colors. The reflection surface is particularly formed by a reflection foil or a reflecting color, however, preferably by glass reflectors.

Preferably, at least one, several or all sensor elements comprise one of the following sensor types as a sensor:

temperature sensor for detecting the temperature;

humidity sensor for detecting the air humidity;

air pressure sensor for detecting the air pressure, wherein said air pressure can be the static air pressure due to weather conditions as well as the dynamic air pressure generated by passing vehicles or wind;

motion sensor for detecting a movement, for example of a vehicle, a person near the roadway, or a (wild) animal near the roadway, wherein the motion sensor may be configured as an infrared sensor, ultrasonic sensor, LIDAR (light detection and ranging) or radar, wherein the motion sensor is particularly adapted for detecting the speed of passing vehicles;

precipitation sensor for detecting precipitation;

anemometer for detecting wind speed;

brightness sensor for detecting light irradiation, for example of solar radiation, and solar altitude, and for detecting headlights of vehicles;

ampermeter and/or voltmeter for determining the generating power or voltage or in general the generated energy of a provided solar cell by light irradiation, or for measuring the electrical consumption of the components of the sensor element;

acceleration sensor for detecting an acceleration and vibration, for example by passing vehicles or persons and wild animals, respectively, within close proximity, as well as seismic activities or anomalies, respectively;

orientation sensor for detecting the orientation of the sensor element;

magnetic field sensor for detecting a changing effect on the magnetic field provided at the sensor element, for example by passing vehicles;

detection device connected to a receiving means of a communication device for detecting a radio signal and a latency time of the transfer by means of the radio signal;

position sensor for determining the position of the respective sensor element, for example by means of a satellite navigation GNSS, such as GPS, Galileo, Beidou, GLONASS or the like;

sensors detecting the presence of vehicles, persons or wild animals, wherein said sensor are configured as infrared sensor, ultrasonic sensor, motion sensor, inductive or capacitive sensor, Hall sensor, LIDAR or radar, for example;

a microphone for detecting sound waves caused by precipitation, passing vehicles, animals or humans as well as for acoustically detecting accidents;

a camera as well as an optical sensor for visually detecting events and states;

a sound level sensor for detecting the sound level caused by the traffic, for example, so that an extensive sound level measurement can be performed, particularly according to EU directive 2002/49/EG;

a sensor for detecting air quality, for example for determining particulate matter, ozone, nitrogen oxides, hydrogen sulfides and the like;

sensor for detecting chemical substances, wherein said chemical substances are, for example, operating materials escaping from the vehicle, escaping dangerous goods loads or chemical substances resulting from fires. The chemical substances can also be the salt content on the road due to a weather-related gritting of salt.

One, several or all sensor elements particularly comprise more than one of said sensors. The provided sensor types can be selected according to the respective applications, so that a versatile device for monitoring the state of roads, infrastructure and traffic is provided. The individual sensor elements can be configured differently or all identically.

Preferably, at least two, in particular identical sensors are arranged at opposite sides of the respective sensor element. Particularly a first side is directed towards the direction of travel and an opposite side is directed opposing the direction of travel. The respective sensor element preferably comprises on all four sides particularly the same sensors. It is thus possible to already receive with a sensor element a spatial distribution or under consideration of the temporal course of the spatial distribution of the measured parameter further indications for an event or state. It is particularly preferred that the sensor is a pressure sensor or a microphone which is arranged on at least two opposite sides and particularly on all four sides of the sensor element. Thus, a spatial resolution is possible through the position of the detected sound source. Moreover, the temporal course of detected vehicle noises can be used to deduce an accident, a vehicle driving in the wrong direction of travel (“ghost driver”), a vehicle having an engine damage, tyre damage or the like as well as the respective vehicle speed. The noise detected in this way can also be used to deduce other events, such as a falling tree or the like.

Preferably, at least one, several or all sensor elements comprise a warning device, wherein the warning device is connected to the evaluation device and generates a warning in case of a given event or state. The warning can be particularly an optical warning, for example in form of one or several LEDs or other light sources, or an acoustic warning tone. Thus, the warning can be issued to passing vehicles or to persons near the roadway, or a warning information can be delivered to arriving emergency personnel. The acoustic or optical warning can also be used to effectively scare away wild animals and/or free ranging animals. The type of warning is generated depending on the detected event or state. It is particularly an event or state which has been detected by a sensor element different from the sensor element generating the warning. The sensor element detecting the event or state is not necessarily identical to the sensor element generating the warning. It is thus possible to early warn approximating vehicles from detected dangers or the like. If a wild animal or free-ranging animal is detected near the roadway by a sensor element, for example, the traffic is warned by the sensor at least 100 m before the event, wherein the given distance is not be understood as limiting and can be adjusted depending on the usual speed of the traffic participants and is particularly selected by means of the vehicle's stopping distance to be expected. However, at the same time, the sensor element which has detected the wild animal or free-ranging animal as well as possibly directly adjacent sensor elements can scare away the wild animal by means of a warning tone or a flashlight.

Preferably, more than one and particularly all sensor elements comprise a communication device for establishing a first, particularly wireless communication connection between the sensor elements. The communication device is adapted for transferring status information of one or several sensor element and/or an event and/or a state of a sensor element to the next sensor element. Thus, a communication network is created for transferring status information, events or states along and by means of the sensor elements. Therefore, it is not required anymore to connect individual sensor element to a common control or receiving station. Upon failure of a sensor element, the data are nevertheless transmitted within the communication network. The transmission of the acquired data by means of the first wireless communication connection can also be carried out up to a sensor element, for example, which has a connection to a central control or the like. It is also possible to transmit the acquired measured parameters by the first wireless communication connection for joint evaluation of the acquired measured parameter by a common evaluation device and/or an evaluation device provided in one of the sensor elements. The first wireless communication connection is particularly a wireless communication connection established by Zig-Bee, Bluetooth, NFC, WiFI, WLAN or comparable radio technology, in particular as sub-GHz radio transmission. Alternatively, the first communication connection is wired, so that the required data are transferred or exchanged, respectively, between the individual connected sensor elements by means of a suitable data cable.

Preferably, at least one, several or all sensor elements comprise a communication device for establishing a second, particularly wireless communication connection between the sensor element and a cloud server or a gateway. The communication device is adapted for transferring a status information of one or several sensor elements and/or a state and/or an event. Alternatively or additionally, it can also be possible to transfer the measured parameters themselves to the cloud server or a gateway, so that the user of the data made available can evaluate said measured parameters according to the individual requirements. Thus, the device is connected by means of the second wireless communication to a cloud server. Status information, measured parameters, events or states are acquired by the cloud server and made available to further users as part of cloud data mining, for example. The second wireless communication connection is particularly established by GSM, 3G, 4G, 5G or a further generation, WLAN or is identical to the first wireless communication connection. Each of the present sensor elements can establish a second wireless communication connection to the cloud server or the gateway, which results in a high failure safety. Alternatively, if only individual sensor elements establish a second wireless communication connection, said sensor elements serve as an uplink to the cloud server. Alternatively, the sensor elements send their data to a gateway which transmits the collected data to the cloud server. If a sensor element thus detects a state or event, said state or event is first transmitted by the first wireless communication connection within the communication network to the sensor element serving as an uplink and is then transferred to the cloud server. As an alternative to a wireless communication connection, the second communication connection is wired, so that data can be exchanged between one or several sensor elements and the cloud server by means of a suitable data cable.

The status information are preferably the state of charge of the battery of the respective sensor element, for example, and/or include further information on the functionality of the respective sensor element.

Preferably, at least one, several or all sensor elements comprise a communication device for establishing a third wireless communication connection between the sensor element and a vehicle or an airplane for exchanging data between the sensor element and the vehicle and/or the airplane. The communication device is configured for transferring, by means of the third wireless communication connection, an event and/or a state to the vehicle and/or airplane and for receiving vehicle information or airplane information, respectively. The vehicle information may include, for example, vehicle type, vehicle speed, travelling time and, in particular for autonomous vehicles, start and/or destination. The airplane information may include, for example, airplane type, airplane speed, flight altitude, planned flight route, travelling time and, in particular for autonomous planes, start and/or destination. The third wireless communication connection is particularly established by means of GSM, 3G, 4G, 5G or a further generation, WLAN or a V2X (vehicle-to-everything) standard. The third wireless communication connection can be particularly identical to the first wireless communication connection and/or the second wireless communication connection. In particular, a measured parameter of one sensor element or of several sensor elements can also be transferred by the third wireless communication connection to the vehicle and/or the airplane and can be evaluated by the vehicle or the airplane itself, respectively. It is thus possible in a simple way by means of the direct communication of the road monitoring system with, for example, autonomous vehicles or autonomous airplanes, such as drones, to transfer the information on the environment, which are required for autonomous driving/flying, to the vehicle or airplane, respectively. Thus, the required data does not need to be routed through a central server, whereby the failure safety, for example by a loss of the radio connection between autonomous vehicles or planes, respectively, and the server, can be improved. At the same time, critical data are quicker available for the autonomous vehicle and/or the autonomous airplane since it is not required to first establish a connection via a server, so that due to the low latency, the autonomous vehicle or airplane, respectively, can introduce safety-relevant measurements, such as braking, in time. Thus, a sensor element can detect an obstacle as an event, for example. This event is then transferred by the third wireless communication connection to approximating, in particular autonomous vehicles and/or airplanes which can brake in time. Braking can already be initiated particularly before the sensors of the autonomous vehicle or airplane, respectively, detect the obstacle. Thus, the limited range of the sensor of autonomous vehicles and autonomous airplanes is compensated by the present disclosure.

The first wireless communication connection and/or the second wireless communication connection and/or the third wireless communication connection is preferably encoded, so that a manipulation of the transferred data is prevented. In doing so, it is particularly ensured that no manipulated data or data of manipulated sensor elements get into the device which could be used for misuse of the device. For this purpose, the individual data can be made identifiable by a hash function, so that the receiver of the data can clearly check the integrity of the data as well as of the transmitter. For this purpose, a blockchain method can be used, for example. Thus, safety is increased.

The sensor elements are preferably configured to be identical. It is particularly preferred that all sensor elements, except one sensor element, are configured to be identical, wherein only the one sensor element comprises a communication device for establishing a second wireless communication connection as an uplink.

A state is preferably a temperature, wherein the state particularly includes critical temperatures which can result in ice formation. A further state is the presence of precipitation, such as rain, hail, snow and the like. A further state is the presence of fog and a reduced sight. A further state is the presence of ice or snow on the roadway and a further state refers to the light conditions, such as solar radiation, solar radiation direction and the like. A further state is the position of the respective sensor element, so that the position of a sensor element on an autonomous vehicle or an autonomous airplane can be transferred as a state together with the distance of the autonomous vehicle or airplane, respectively, from the sensor element. A further state is the normal state without any further states and/or events, wherein this state a riskless driving or flying is possible. A further state is the sound level which is particularly generated by the traffic participants. A further state is the salt content on the road during a weather-related gritting of salt.

The event is preferably a traffic jam and a tail end of the traffic jam, for example. A further event is the passing-through of a vehicle or the presence of a vehicle or an airplane in the sensor area of a respective sensor element. A further event is the vehicle differentiation, for example between passenger vehicle and commercial vehicle, by means of the generated noise, the generated vibrations, the length of the vehicle of the like. A further event is the vehicle weight of a passing vehicle which is detected by vibrations, for example. A further event is the vehicle speed which is determined by the pass-by speed of the vehicle or the fly-by speed of an airplane at a single sensor or which is determined by the combined detection of several sensor elements. A further event is the breakdown of a vehicle, an accident or a flat tyre which is also detected by the generated noise, for example. A further event are persons on the roadway or wild animals near or on the roadway which are detected by infrared sensors, ultrasonic sensors or image capturing, for example. A further event is the damage to roads, for example by the formation of potholes or changes in state of roadway crossing, which can be identified, in particular, by means of a changed driving noise. A further event is the damage to a structure adjoining the road, such as road lighting, road signs, crash barriers, sound protection and the like. Thus, a failure of the road lighting can be identified by a reduction in background brightness at the location of the sensor element, for example.

Preferably, in one, several or all sensor elements, the respective electronics are brought together on one joint module or PCB (printed circuit board), respectively, so that a rapid replacement of the electronics is guaranteed in case of maintenance. Thus, the maintenance effort is reduced.

The present disclosure further relates to a method for monitoring the state of roads, infrastructure and traffic with a device as described above. In the method, an event and/or a state is detected by a sensor element and, depending of the detected state, at least one of the following steps is performed:

Generating a warning and issuing the warning by means of a warning device. If a tail end of a traffic jam is detected by a sensor element, for example, a warning of slow-moving traffic can be issued. The warning can be an acoustic or an optical warning. If persons are recognized near the roadway, for example, a warning is also issued by one or several sensor elements. If a vehicle is detected that drives in the wrong direction of travel, a warning of this vehicle can also be issued by the respective sensor elements. A warning can also be issued to wild animals and/or free-ranging animals to scare them away, provided that wild animals and/or free-ranging animals are detected near the roadway.

Alternatively or additionally, a status information of at least one sensor element and/or the detected event and/or the detected state and/or the detected measured parameter itself is transferred to a cloud server and is thereby made available for further use. The status information can be a state of charge of the battery of a sensor element or generally the functionality of a specific sensor element. The transferred events or states may include a traffic density, a speed detection, weather data or the like, for example.

Alternatively or additionally, a transfer of the detected event or state to an autonomous vehicle, in particular, and/or an autonomous airplane, in particular, is carried out. The event or state can be the position of the respective sensor element and/or the distance of the vehicle to the roadside or road surface, or a normal state—“Everything ok”—so that the autonomous vehicle or airplane can continue driving or flying, respectively.

The method preferably comprises, when an event or state is present, wherein the event and/or state is transferred to an autonomous vehicle, in particular, and/or an autonomous airplane and, and depending on the event and/or the state, at least one of the following steps:

Generating a warning in the vehicle and/or airplane, for example of wild animals and/or free-ranging animals near or on the roadway, traffic jam, the tail end of a traffic jam, persons in the area of the roadway, roadway or weather conditions such as snow, ice, wind, or an accident. The warning is generated in the vehicle or airplane, for example by an acoustic indication, an optical indication or the like.

Alternatively or additionally, depending on the event and/or state, there is a change in the planned route of the vehicle or airplane. As a result, a traffic jam or a road closure due to an accident, or another obstacle can be avoided in order to achieve the shortest possible travelling time.

Alternatively or additionally, the determined destination arrival time is adjusted depending on whether a traffic jam or disturbances on the planned route are determined by the device.

Alternatively or additionally, in particular for autonomous vehicles or autonomous airplanes, there is a change in the movement direction, in the speed, for example by braking the vehicle or airplane, in case of a danger, or a change in another parameter, for example turning on the vehicle lighting in case of beginning darkness or another view-obstructing event, such as rain, snow or hail. Thus, it is possible to directly communication via the road monitoring system with an autonomous vehicle, in particular, or an autonomous airplane and to provide required data, in particular for safe driving or safe flying, respectively. Thus, it is also possible, for example, when detecting an obstacle that is not yet located within the area of the sensors of the autonomous vehicle and/or airplane, to already early initiate braking. Thus, the device of the present disclosure and the sensor system of an autonomous vehicle or an autonomous airplane complement each other in order to create an improved safety in autonomous movement of vehicles or airplanes, respectively.

The method preferably comprises the step that the status information and/or the event and/or the state and/or a measured parameter itself is transferred to a cloud server, and depending on the status information and/or the event and/or the state and/or the measured parameter at least one of the following steps is performed:

Detecting and evaluating a traffic volume. The data detected in this way can be used when planning new roads or laying out and changing existing roads, for example.

Alternatively or additionally, an automatic routing of the vehicle occurs, in particular on automatic display panels based on the detected traffic volume or traffic obstructions such as accidents or closures. Alternatively or additionally, the routing information can be directly transferred to, in particular, autonomous vehicles and/or autonomous airplanes, whereby routing of the autonomous vehicles or airplanes is adjusted. In case of an increased traffic volume, a part of the vehicles can thus be redirected by routing via a side road, so that overall a traffic jam is prevented on the main route. Moreover, recommendations for the route, for example via automatic display panels, can also be generated by routing. It is also possible to indicate the travel time to a next destination on automatic display panels or road signs, respectively, based on the detected events and/or states.

Alternatively or additionally, travelling of a vehicle or airplane is retraced within the section. For example, a vehicle-specific or airplane-specific signature can be continuously detected by the sensor elements and thus the vehicle or airplane can be retraced in order to detect its route. The vehicle- or airplane-specific signature is a specific vibration, for example, which is detected by the respective sensor element, an optical, visual observation, a specific acoustic or an inductively measured signature or the like.

Alternatively or additionally, depending on the detected event and/or state, an emergency call is initiated in case of an accident. If an accident is detected by a sensor element, for example, an emergency call can be generated automatically.

Alternatively or additionally, a warning is generated on an automatic display panel depending of the transferred event and/or state. The warning can be a warning of weather influences, traffic jam, tail end of traffic jam, accident or an obstacle on the roadway or the like, for example.

Alternatively or additionally, depending on the transferred status information, a maintenance is initiated. If it is detected based on the status information, for example, that one of the sensor elements malfunctions, this can be fixed by initiating the maintenance.

Alternatively or additionally, depending on the detected sound level, an extensive evaluation of the noise pollution by the traffic on the respective road or roadway is carried out. Thus, in particular an extensive sound level measurement according to EU directive 2002/49/EG can be carried out.

Alternatively or additionally, depending on the detected event and/or state, a road maintenance can be initiated in case of damages to the road itself, for example by formation of potholes, or damages to adjoining structures, such as road lightning, road signs, crash barriers, sound protection and the like.

Alternatively or additionally, depending on the detected result and/or state, operational services, such as bulldozers, gritting vehicles, road sweepers or vehicles for cutting and removing road vegetation, are initiated and coordinated. Bulldozers and gritting vehicles, for example, can be coordinated such that first of all essential traffic points are cleared. Alternatively or additionally, the gritting vehicles can also be coordinated by means of the salt content on the road, wherein an application amount of salt as well as the arrival frequency of the gritting vehicles is coordinated.

In the method which transfers events and/or states to a weather station and depending on event and/or state, preferably at least one of the following steps is performed:

Generating a weather warning. The weather warning includes, for example, a specific naming of the danger, such as thunderstorm, storm, snow or the like as well as a position at which the danger occurs.

Alternatively or additionally, depending on the transferred event and/or state, a weather forecast can be created. Due to the plurality of provided sensor elements, a small grid is created which allows for a precise detection of weather data, whereby the precision of a weather forecast is improved, in particular for a specific location.

### BRIEF DESCRIPTION OF THE DRAWINGS

In the following, the disclosure is described in more detail by means of the preferred embodiment with reference to the accompanying drawings in which:

FIG. 1 shows an embodiment of the sensor element, FIG. 2 shows a schematic structure of a sensor element,

FIG. 3 shows an embodiment of the road monitoring system according to the disclosure,

FIG. 4 shows a flow diagram of a method according to the disclosure, FIG. 5 shows a flow diagram of a further method according to the disclosure,

FIG. 6 shows a flow diagram of a further method according to the disclosure, and

FIG. 7 shows a flow diagram of a further method according to the disclosure.

### DESCRIPTION OF THE INVENTION

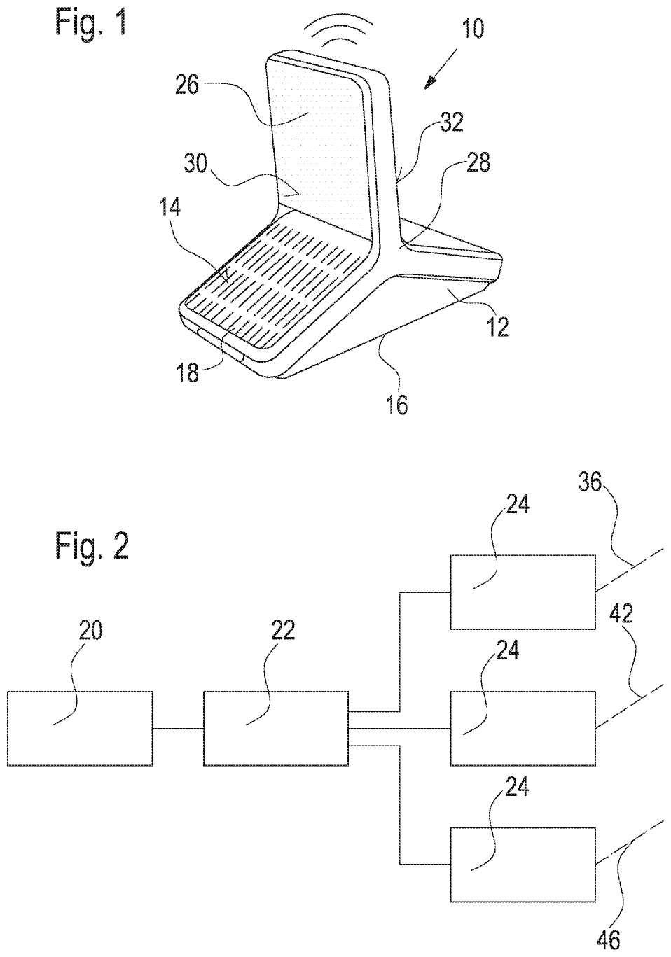

The sensor element 10, shown in FIG. 1, comprises a housing 12 with an upper side 14 and an underside 16. Underside 16 is standing on a road surface and is secured thereto. Alternatively, the sensor element is arranged in the environment of the traffic infrastructure. At the upper side 14 of the housing 12, a solar module 18 is arranged for self-sufficient power supply of the sensor element 10. Furthermore, for supporting the power supply, at least one battery or at least one accumulator is arranged inside the housing 12 which can be charged by the solar module 18. Alternatively or additionally, a wired power supply can be provided. At least one sensor 20 (FIG. 2) is also arranged in the housing 12. An evaluation device 22 connected to the sensor 20 is also arranged in the housing 12. Furthermore, the sensor element 10 can comprise one or several communication devices 24. Said communication devices can be configured as separate communication devices or can be summarized to a joint communication device 24. Parts of the sensor 20 can also be arranged outside the housing 12, for example for detecting a wind speed or the like.

In the example shown in FIG. 1, at the upper side 14 of the sensor element 10, a reflector element 26 is arranged which is particularly connected through a flexible connecting element 28 to the sensor element 10. Alternatively, the reflector element 28 and the sensor element 10 can be connected through a snap-fit connection, for example. The reflector element 26 comprises a front side 30 and a rear side 32 which are provided with reflectors, in particular glass reflectors, wherein other reflectors are also possible, for example made of reflection foils of plastic or other reflecting materials. The reflector element can of course also be arranged on each other side of the sensor element.

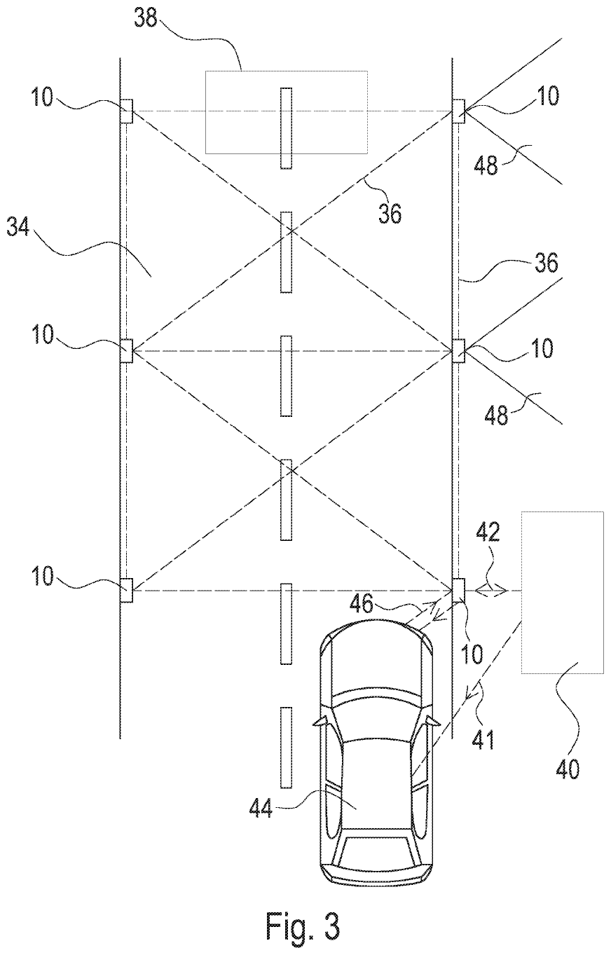

FIG. 3 shows the road monitoring system according to the disclosure with a plurality of sensor elements 10 arranged along a road 34 or a road section, respectively. The sensor elements 10 are particularly arranged equidistantly.

The sensor 20 of the respective sensor element 10 detects a state or an event. The state or event may include, for example, the detection of vehicles, vehicle types, vehicle weight, vehicle speed, traffic jam, tail end of traffic jam, an accident or a broken-down vehicle as well as person on the roadway or wild animals and/or free-ranging animals near or on the roadway or the like. By the sensors 20 of the respective sensor element 10 also a state can be detected, such as temperature, precipitation as rain, hail, snow or the like, fog and restricted view, standing water, ice on the road surface and snow, the prevailing light conditions, noise as well as storm and wind conditions. The control elements can also detect or save their respective position.

By means of communication device 24, a first wireless communication connection 36 can be established, for example based on ZigBee, Bluetooth, NFC, WiFi, WLAN or the like. Thus, a communication network or grid is created, whereby the respective sensor elements 10 are in connection with each other and thus the transmission of status information or the reception of data, or the transmission of measured parameters via individual sensor elements 10 as well as states and events is made possible. By creating the grid, the road monitoring system becomes particularly fail-safe since, for example upon failure of one of the sensor elements 10, the transmission of states and events via the other sensor elements 10 can be carried out by means of the network grid. As an alternative to the formation of a grid based on a wireless communication connection, the first communication connection can be established in a wired manner between the individual sensor elements.

Furthermore, the sensor elements 10 can communicate by means of communication device 24 with a cloud server 40 or a gateway by means of a second wireless communication connection 42. Alternatively, the second communication connection is a wired communication connection. All sensor elements 10 can be configured for communicating by means of a second communication connection 42 with cloud server 40. Alternatively, only some sensor elements 10 or only one sensor element 10 can communicate by means of a second wireless communication connection 42 with cloud server 40. Said one sensor element 10 serves as an uplink or downlink to the cloud server 40. Status information, detected/measured parameters and events or states being detected by the other sensor elements 10 are transferred by means of the first wireless communication connection 36 to the sensor element 10, which serves as an uplink and downlink, and are then transferred to the cloud server 40. In the cloud server 40, the events or states detected by the road monitoring system are retrievable and can be used, for example, particularly by means of data mining for traffic analysis in order to create traffic-adjusted routes, predict events and states, particularly those disturbing the traffic flow or being a danger for the respective traffic participants, preferably based on recurring patterns leading to the respective events or states, recurring events or an increased probability for the occurrence of such events or states. They are also used particularly by autonomous vehicles, for controlling automatic display panels along roads which include recommendations or information on travelling times. Furthermore, cloud server 40 can transmit weather data in order to create a weather forecast or the like. By means of the traffic analysis, it is also possible to plan new traffic routes or adjust existing traffic routes in a suitable manner. Moreover, the events and/or states detected in this way can be transmitted to vehicles 44 and/or airplanes moving along the traffic infrastructure by means of a further wireless communication 41, and thus the detected traffic data can be used, for example, particularly by autonomous vehicles 44 or particularly by autonomous airplanes for creating efficient routes from a start point to a destination point. The autonomous aerial vehicles are particularly UAVs (unmanned aerial vehicle), drones, helicopters, multicopters or the like.

Moreover, the sensor elements 10 can communicate by means of communication device 24 with vehicles 44 or airplanes via a third wireless communication connection 46. In doing so, the positions of the respective sensor elements 10 can be transmitted to the vehicle 44 or the airplane, for example, so that an exact positioning of the vehicle 44 or of the airplane is always enabled. Further information can be transferred to the vehicle and/or the airplane, such as the occurrence of an obstacle 38. Thus, vehicle 44 or the airplane is not solely dependent on its on-board sensors anymore. The events and states detected by the sensor elements 10 can rather be transmitted to vehicle 44 or the airplane and can thus warn the vehicle passenger or the pilot and can control, particularly for autonomous vehicles, the vehicle or, for autonomous airplanes, the airplane in a suitable manner, for example by braking, in order to prevent an accident, collision or crash. Thus, autonomous vehicle 44 and airplanes can drive or fly more anticipatory than the on-board sensors would permit.

Particularly at least one of the sensor elements 10, several sensor elements 10 or all sensor elements 10 comprise one or several of the following sensors or components which are supplied individually or in combination to corresponding computational models:

Microphone:
For detecting a driving noise of a passing vehicle and particularly for detecting the vehicle type, so that smaller passenger vehicles can be distinguished from commercial vehicles or the like, for example.
For detecting a flight noise of a passing airplane and particularly for detecting the airplane type, so that various drones can be distinguished, for example.
Furthermore, the traffic flow can be monitored by the detected noise, so that in the event of a traffic jam or an abrupt stop and the associated change in the acoustic signature, a traffic jam or a blockage of the road can be inferred.
Moreover, accident noise can be detected and evaluated, so that an accident can be easily detected.
The acoustic signature can also be detected by breaking structures and thus a tree falling on the traffic route or the like can be inferred.
Furthermore, the change in tyre rolling noise of vehicles can be monitored, so that a damage to the roadway can be deduced from a changed acoustic. The acoustic of a passing vehicle is changed by a pothole, so that a pothole or other damages to the road can be simply detected in order to then initiate a maintenance. In case of bridges or roadway crossings, a changed driving noise can indicate a damage to the bridge construction, so that upon a change in the detected driving noise, a maintenance can be initiated.
Moreover, the microphone for recording the sound level caused by the traffic, for example, can be used, so that an extensive sound level measurement can be performed, particularly according to EU directive 2002/49/EG;
Furthermore, more than one microphone can be provided in a sensor element 10, so than an information on the temporal course of the noise can be obtained. For this purpose, particularly at least one microphone is arranged opposite to the direction of movement and one microphone is arranged in the direction of movement. In this way, the speed can be deduced from the temporal course of the vehicle or flight noise.
In addition, more than one microphone can be provided in a sensor element 10, so that an information on the temporal course of the noise can be obtained. For this purpose, particularly at least one microphone is arranged opposed to the direction of travel and one microphone is arranged in the direction of travel. Thus, the direction of travel can be deduced easily, whereby ghost drivers can be detected quickly, for example.

Pressure sensor:
For detecting the meteorological pressure and for usage in a weather forecast.
For detecting the pressure due to wind, wherein particularly the sensor element comprises pressure sensors on at least two and preferably on all four sides, so that the wind direction can also be determined. Particularly in case of high wind speeds at fragile constructions, such as bridges or the like, a warning, blockage and/or maintenance can be initiated upon detection of a high wind speed.
For detecting the dynamic pressure of a passing vehicle in order to detect the vehicle. Thus, the presence of a vehicle can be easily inferred.
Furthermore, more than one pressure sensor can be provided in a sensor element 10, so that an information on the temporal course of the pressure can be obtained. For this purpose, particularly at least one pressure sensor is arranged opposed to the direction of travel and one pressure sensor is arranged in the direction of travel. Thus, the direction of travel of a vehicle can be easily inferred, whereby ghost drivers can detected quickly, for example.
Moreover, more than one pressure sensor can be provided in a sensor element 10, so that an information on the temporal course of the pressure can be obtained. For this purpose, particularly at least one pressure sensor is arranged opposed to the direction of travel and one pressure sensor is arranged in the direction of travel. Thus, the speed of a vehicle can be easily inferred.
In addition, the probability of weather events (e.g. ice formation) can be deduced from a change in pressure in combination with other sensors.

Air humidity sensor: For detecting the humidity for usage in a weather forecast, in particular for determining a precipitation probability or the visibility conditions, for example through fog.

Temperature sensor:
For detecting the temperature for usage in a weather forecast, in particular for determining a precipitation probability, ice formation, snowfall or the like.
Furthermore, the temperature can be detected in order to make a statement on the strain on the used battery or accumulator in the sensor element 10, so that in case of a persisting low temperature and an accelerated aging of the battery or the accumulator associated therewith, a maintenance can be initiated.

Acceleration sensor:
For detecting vibrations causes by passing vehicles and particularly for detecting the vehicle type, so that smaller passenger vehicles can be distinguished from commercial vehicles or the like, for example.
For detecting a traffic accident by the vibrations caused thereby which are different from the usual vibrations of a passing vehicle. Falling trees or the like can also be registered by means of the caused vibrations detected by the acceleration sensor.
For detecting changing oscillation behavior of bridge constructions, galleries or tunnels. Thus, a changing structure, for example due to ageing of the construction, can be easily inferred and a maintenance, warning and/or blockage can be initiated in time.
For detecting road damages, such as potholes, by generated vibrations which only change when the road damages occur. Thus, a change in the road, such as a damage, can be deduced from the change in vibrations and a warning, blockage and/or maintenance can be initiated.
For detecting changing oscillation signatures of vehicles. Thus, a changing structure, for example due to scouring, landslides, fundament damages or the like, can be inferred and a maintenance, warning and/or blockage can be initiated in time.
For particularly extensive seismic detection of earth tremors or earth movements.

Location sensor:
For detecting a traffic accident. If the sensor element is mounted on a crash barrier, for example, and if in the event of a traffic accident, a vehicle involved in an accident hits the crash barrier, the location of the mounted sensor element 10 changes, so that a traffic accident can be inferred. The same applies, for example, if the sensor element is hit by a tree falling on the road or if a construction to which the sensor element 10 is connected is obviously damaged.
Furthermore, the location sensor can detect a changing location due to theft and can generate and transmit a corresponding event.

Magnetic field sensor:
For detecting vehicles or airplanes by a changing detected magnetic field. Individual vehicles or airplanes particularly comprise a unique signature of a magnetic field change, so that the corresponding vehicles or airplanes can be identified by further sensor elements 10, such that the driving or flying speed and the direction of movement can be detected, for example.
Moreover, in case of a long-term change, a changing magnetic field can be used to infer to a changing structure of the road, the bridge or the tunnel, so that a corresponding warning, blockage and/or warning is initiated.

Ampermeter and/or voltmeter:
For determining a power produced by a solar cell, so that brightness and sunshine can be inferred.
Furthermore, by determining power produced by a solar cell, snow can be inferred which covers the solar cell, so that the solar cell does not produce power anymore.
Moreover, by determining power produced by a solar cell, a contamination of the solar cell can be inferred which can result in an insufficient power supply of sensor element 10, so that a corresponding maintenance is initiated. This particularly applies if the detected current value is compared to past current values of the same solar cell, in particular for same or similar weather conditions. Instead of same weather conditions, a maximum value of the generated power can also be used.

Sensor connected to a communication device
For detecting the received signal strength and/or a latency time. The communication device is particularly a telecommunication device of 3G, 4G, 5G or a further generation. However, further radio connections are also possible. Particularly for autonomous driving and flying, fast data connections between the vehicles or airplanes and an infrastructure or a server with a low latency are required. These data transmission rates and latency times must be monitored in order to issue a warning if they fall below. With the above-described sensor, this is extensively possible along the driveway/air lane, so that there is always a proof and/or certainty that the required data rates and latency times are given. If data rates or latency times are not sufficient, a warning can be issued in time, in particular to autonomous vehicles and/or autonomous airplanes.
Furthermore, a communication device can be used to exchange, by exchanging a signal, a position information with an autonomous vehicle, in particular, and/or an autonomous airplane, in particular, and to thus guarantee a safe navigation.

Position sensor:
For determining the exact position of the respective sensor element 10, so that said sensor element can transmit its exact position, for example by V2I-communication, to vehicles.
Furthermore, the position sensor can detect a changing position due to theft and can generate and transmit a corresponding event.
Moreover, a damage to the construction, such as road, tunnels or bridges, can be determined by means of a changed position.

Air quality sensor:
For determining the air quality, for example for generating a smog alarm, for determining the particulate matter values, for example for local driving bans or the like.

All aforementioned events and states, which are detected by the individual sensors, are transferred as measured parameters to a cloud server or gateway and are correspondingly evaluated or are evaluated by an evaluation device included in the respective sensor element 10. Hereinafter, the usage of the determined state and/or event by transmission for generating a corresponding maintenance follows, the transmission and usage by an autonomous vehicle, in particular, and/or an autonomous airplane, in particular, the transmission and usage by initiating a blockage and/or issuing a warning, the transmission and usage to police or operational services for guaranteeing the safe use of the road or the traffic route, for example by maintenance and particularly by maintenance of the road monitoring system itself. Individual sensor elements can comprise one, several or all above-described sensors, wherein one, several or all mentioned events or states are actually detected by the respective sensor. For example, a temperature sensor can be provided, however, the temperature sensor is not used to create a prediction for battery ageing or the like.

Particularly one, several or each of the provided sensor elements can comprise one or more light sources being particularly configured as LED light sources.

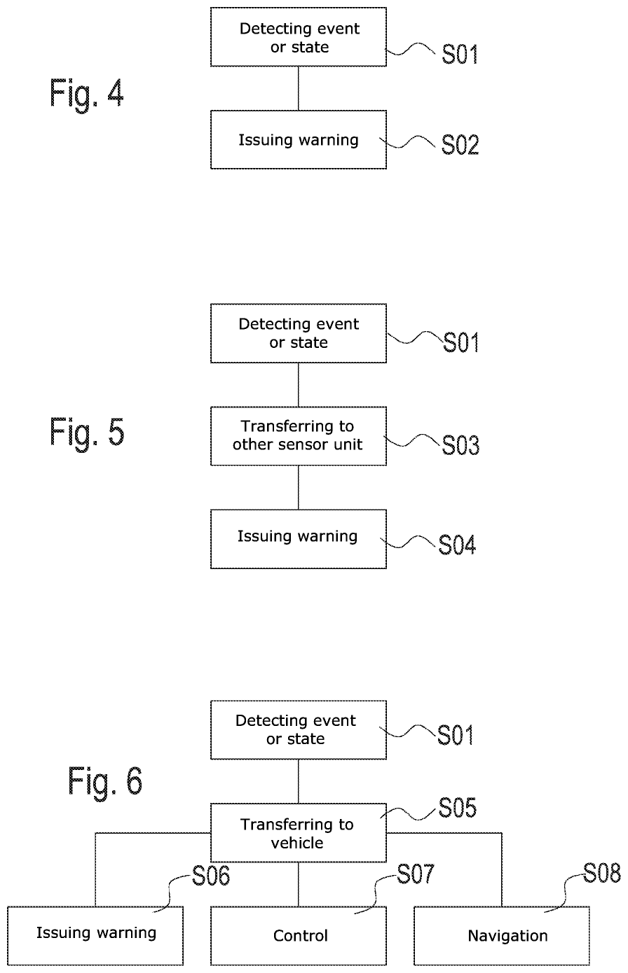

FIG. 4 shows a method according to the disclosure, where first an event or state is detected S01 by a sensor element 10 and then the same sensor element 10 issues S02 a warning, wherein the warning can be an optical or acoustic warning, for example. It is indicated in FIG. 3 that the sensor elements 10 comprise a sensor area 48 in which the occurrence of wild animals and/or free-ranging animals is detected. The schematically illustrated sensor area comprises up to 360°. If one of the sensor elements 10 detects a wild animal and/or a free-ranging animal in the sensor area 48, a warning in form of an acoustic signal can be issued in order to keep the wild animal and/or the free-ranging animal away from the road 34.

In a further embodiment, as shown in FIG. 5, the event or the state detected S01 by the first sensor element 10 is first transmitted S03 to another sensor unit by means of a first wireless or wired communication connection 36 and then a warning in form of an optical warning or an acoustic warning is issued S04 by the further sensor element 10. If an obstacle 38 or a wild animal and/or a free-ranging animal is detected in the sensor area 48 by one of the sensor elements 10, for example, said event is transferred to a sensor element 10 being farther away opposed to the direction of travel by means of the first communication connection 36 and said sensor element 10 being farther away issues a warning, so that the traffic and particularly the vehicle 44 are warned in time of possible dangers, such as obstacle 38 or the approximating wild animals or free-ranging animals.

In a further embodiment, as shown in FIG. 6, after detecting an event or a state of a sensor unit S01, the detected state or the event is transmitted to a vehicle 44 and/or an airplane S05. A warning is then issued S06 in the vehicle 44 and/or the airplane, alternatively or additionally, due to the detected event or state, the control of the vehicle 44 and/or the airplane is adjusted S07, for example by braking the vehicle 44 or the airplane. Alternatively or additionally, depending on the detected event or state, the navigation of the vehicle or airplane is changed S08, so that a traffic jam or an obstacle can be avoided spaciously.

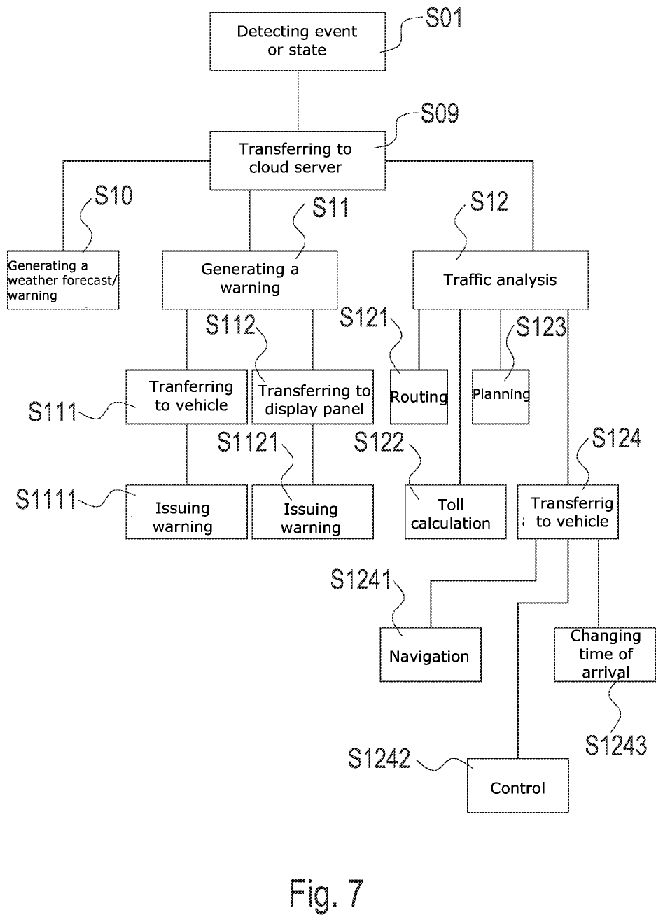

In a further embodiment of the method according to the disclosure shown in FIG. 7, the detected event or the detected state S01 is transferred to a cloud server or a gateway S09. It is possible by means of the transferred events and/or states and/or measured parameters to create a weather forecast or a weather warning S10, provided that the transferred events or states are weather data or weather-relevant data. Alternatively or additionally, it is possible, depending on the detected event or state, to generate a warning S11. Said warning can then be transferred to a vehicle 44 or an airplane S111 and can be issued therein in order to warn passengers of the vehicle 44 S1111 or the airplane. Alternatively or additionally, it is possible to transfer the warning to a display panel S112 which issues the warning S1121, so that passing vehicles 44 can detect the warning. Alternatively or additionally, the warning can be transferred to a control center.

Alternatively or additionally, it is possible by means of the events or states transferred to the cloud server 40 or the gateway to perform a traffic analysis S12. It is possible by means of said traffic analysis to perform an intelligent routing of the traffic participants S121, so that congested roads are relieved and vehicles 44 are redirected to side roads, however, without that there is a congestion of the side road. A routing of the airplanes can also be performed based on the respective lane utilization. The events and states transferred to the cloud server can also be used in a data mining method for predicting events and states, in particular those disturbing the traffic flow or being a danger for the respective traffic participants, preferably based on recurring patterns leading to the respective events or states, recurring events or an increased probability for the occurrence of such events or states. Furthermore, the data detected in this way can be considered in planning new traffic routes S123. It is further possible, due to the detected events and states, to perform a toll calculation S122, provided that individual vehicles are retraced along their route. Thus, the amount of the toll to be charged can be determined.

Alternatively or additionally, a transfer of the detected traffic analysis to vehicle 44 is performed S124. Said transferred traffic analysis can be considered in navigation, which is when adjusting a route between a given start and a given destination S1241. Particularly for autonomous vehicles and/or autonomous airplanes, the transferred data can be used for changing the control of the autonomous vehicle S1242 or the autonomous airplane. When predicting the expected time of arrival S1243, the traffic analysis data, which are transferred from cloud server 40 to vehicle 44, can also be used.

1. A device for monitoring the state of roads, infrastructure and traffic, comprising
a plurality of sensor elements, wherein the plurality of sensor elements are arranged along at least one section of a road or a traffic route,
wherein the plurality of sensor elements each comprise:
a housing having an underside, and an upper side,
at least one sensor for detecting a measured parameter,
wherein the at least one sensor is connected to an evaluation device arranged inside the housing,
wherein the evaluation device is configured such that an event or state is determinable from the detected measured parameter.

2. The device according to claim 1, wherein at least one sensor element comprises a solar cell, wherein the solar cell is arranged at the upper side of the housing or comprises a wired power supply.

3. The device according to claim 1, wherein at least one sensor element comprises a reflector element.

4. The device according to claim 1, wherein at least one sensor element comprises at least one of the following sensor types as a sensor: temperature sensor, humidity sensor, air pressure sensor, motion sensor, acceleration sensor, microphone, brightness sensor, IR sensor, ultrasonic sensor, anemometer, LIDAR, radar, precipitation sensor, Hall sensor, inductive or capacitive sensor, magnetic field sensor, ammeter, voltmeter, location sensor, camera and optical sensor, sound level sensor, sensor for detecting air quality and sensor for detecting chemical substances.

5. The device according to claim 1, wherein at least one sensor element comprises a warning device, wherein the warning device is connected to the evaluation device and a warning is generated for the given event or state.

6. The device according to claim 1, wherein more than one sensor element comprises a communication device for generating a first communication connection between the sensor elements, wherein the communication device is configured to transfer or receive a status information of one or several sensor elements or the event or the state.

7. The device according to claim 1, wherein at least one sensor element comprises a communication device for generating a second communication connection between a sensor element and a cloud server or gateway, wherein the communication device is configured to transfer or receive a status information of one or several sensor elements or the event or the state.

8. The device according to claim 1, wherein at least one sensor comprises a communication device for generating a third wireless communication connection between a sensor element and a vehicle or an airplane, wherein the communication device is configured to transfer or receive the event or state.

9. A method for monitoring a state of roads, infrastructure and traffic with a device according to claim 1, in which one of the plurality of sensor elements detects the event or the state and at least one of the following steps is performed depending on the detected event or state:
generating a warning and issuing the warning by means of a warning device;
transferring a status information of at least one sensor element or of the detected event or state or of a measured parameter detected by a sensor element to a cloud sever;
transferring the detected event or state or the measured parameter detected by the sensor element to an autonomous vehicle or an autonomous airplane.

10. The method according to claim 9, in which, upon occurrence of the event or state, the event or state is transferred to a vehicle or airplane and at least one of the following steps is performed depending on the event or state:
generating the warning in the vehicle or airplane:
changing a driving route or flight route;
adjusting the determined destination arrival time;
changing direction of travel, driving speed or another driving parameter;
changing flight direction, flight speed, flight altitude or another flight parameter.

11. The method according to claim 9, in which the status information or the event or the state is transferred to the cloud server or gateway and at least one of the following steps is performed depending on the status information or the event or the state:
detecting a traffic volume;
routing route recommendations, indication of travel time on road signs to a next destination;
retracing a travelling of a vehicle or airplane within the at least one section;
initiating an emergency call in case of an accident;
generating the warning on a display panel;
transmitting the warning to a control center;
initiating a maintenance of a sensor element;
evaluating an extensive sound level measurement;
initiating a road maintenance in case of damages to the road or adjoining structures; and
initiating and coordinating operational services for guaranteeing a safe use of the road or the traffic route.

12. The method according to claim 1, in which the event or state is transmitted to a weather station and at least one of the following steps is performed depending on the event or state:
generating a weather warning;
generating a weather forecast.
